(19) United States
(12) Patent Application Publication
(10) Pub. No.: US 2003/0150743 A1
(43) Pub. Date: Aug. 14, 2003

(54) Tin or tin alloy plating bath, tin salt solution and acid or complexing agent solution for preparing or controlling and making up the plating bath, and electrical and electric components prepared by the use of the plating bath

(75) Inventors: Keigo Obata, Akashi-shi (JP); Masakazu Yoshimoto, Akashi-shi (JP); Kiyotaka Tsuji, Kobe-shi (JP); Ei Uchida, Kobe-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: DAIWA FINE CHEMICALS CO., LTD.

(21) Appl. No.: 10/247,936

(22) Filed: Sep. 20, 2002

(30) Foreign Application Priority Data
Sep. 20, 2001 (JP) 2001-286554

(51) Int. Cl. C25D 3/58; C25D 3/60; C25D 3/30; C09D 5/00

(52) U.S. Cl. 205/252; 205/253; 205/300; 106/1.25

(57) ABSTRACT

There are provided a tin or tin-base alloy plating bath having significantly improved solderability, a tin salt solution and an acid or complexing agent solution for preparing or controlling and making up the plating bath, as well as electrical and electric components prepared by the use of the plating bath.

The plating bath is a tin plating bath or a plating bath of an alloy of tin and one or more metals selected from the following group (I): copper, zinc, silver, indium, gold and bismuth, which bath comprises, as essential components, at least the following components (A) to (D):

(A) 5 to 200 g/L of divalent tin ions,

(B) one or more acids or complexing agents which form a water-soluble salt or complex with the divalent tin ions, the total amount of the acid(s) or complexing agent(s) being at least stoichiometrically equivalent to the divalent tin ions,

(C) one or more metals selected from elements of Groups IB to VB of the fourth to sixth periods of the periodic table of the elements excluding tin, mercury, thallium and elements included in the group (I), the total concentration of the metal(s) being 20 to 2,000 ppm based on tin, and

(D) 1 mg/L to 10 g/L of one or more antioxidants.

### BACKGROUND OF THE INVENTION

(i) Field of the Invention

The present invention relates to a plating technique, particularly to a plating bath for obtaining tin and/or tin alloy deposits which exhibit good solderability, a tin salt, acid or complexing agent solution used for preparing, controlling and making up the bath or for adjusting a concentration of the bath, and electrical and electric components prepared by the use of the plating bath.

(ii) Description of the Related Art

In order to prevent environmental pollution caused by lead eluted from tin-lead solders used in electrical and electric components, a number of studies have been made on lead-free solders (soldering materials). In corporation with these studies, for the plated films to which these soldering materials were applied, studies have been also made to replace the conventionally widely used tin-lead alloy plated film with an alternate lead-free film. Although a plated film of gold, silver, palladium or the like has also been studied as the alternate film, it is believed that a main plated film will be a tin plated film or a tin alloy plated film. Mainly, in the last several years, as an alternate for the tin-lead alloy plating, a number of reports have been made or patent applications have been submitted with respect to lead-free tin alloy plating (so-called lead-free plating), such as tin-copper, tin-zinc, tin-silver, tin-indium and tin-bismuth alloy plating.

However, the tin-lead alloy plated film is an alloy which is extremely suitable for soldering and, in fact, it is a current situation that lead-free plated films having solderability comparable to that of the tin-lead alloy plated film have not been obtained yet in the so-called lead-free plated films.

We have chosen, as an object to be studied in the present invention, to improve solderability of the so-called lead-free solderable film while minimizing influences of harmful metal elements such as lead on the environment, thereby solving environmental problems caused by lead.

We have found that solderability of the tin and tin alloy plated films can be significantly improved by adding, in a very small amount, lead which has been heretofore attempted by researchers and developers of lead-free solderable films to remove it completely therefrom. In addition, we have also found that the solderability can be significantly improved by adding a metal other than lead whose addition to a lead-free plating bath in a very small amount has heretofore not been studied due to its toxicity and costs, i.e., a low-melting metal which can be found in the vicinity of lead in the periodic table of the elements and is not a component of the tin alloy deposits, more specifically, a metal such as arsenic, cadmium, antimony, gallium or germanium, to a tin or tin alloy plating bath in a minimum required concentration in consideration of the environment. The environmental problems caused by lead in the plated film for soldering have been solved by these findings.

### SUMMARY OF THE INVENTION

Therefore, subjects of the present invention are:

a tin plating bath which contains one or more metals selected from elements of the Groups IB to VB of the fourth to sixth periods of the periodic table of the elements excluding tin, mercury, thallium, and elements included in the following group (I); copper, zinc, silver, indium, gold and bismuth (hereinafter referred to as “alloying metal”), more specifically, one or more metals selected from antimony, arsenic, cadmium, germanium, gallium or lead, in a total amount limited to a range from 20 ppm to 2,000 ppm based on tin, or a tin alloy plating bath which contains tin and one or more metals selected from the above alloying metal;

a tin salt solution and an acid or complexing agent solution used for preparing, controlling and making up the bath or for adjusting a concentration of the bath; and

electrical and electric components on which tin or tin alloy deposits was plated by the use of the bath, such as a semiconductor device, a printed circuit board, a flexible printed circuit board, a film carrier, a connector, a switch, a resistor, a variable resistor, a condenser, a filter, an inductor, a thermistor, a quartz oscillator, a lead wire, and an electrode for a battery.

### DETAILED DESCRIPTION OF THE PREFERRED EMBODIMENT

The above metals (hereinafter referred to as “metal(s) to be added in a very small amount”) selected from elements of Groups IB to VB of the fourth to sixth periods of the periodic table of the elements excluding tin, mercury, thallium and the elements included in the above group (I) exhibit a certain effect even if used alone or in combination of two or more and are suitably used. Antimony, arsenic, cadmium, germanium or gallium is more preferably used, and of these, antimony or arsenic is most preferably used. However, since codeposition of these metals is considered to be effective even in a very small amount, the codeposition i.e. has not necessarily been confirmed in all cases. Although it was confirmed that these metals were effective in improving solderability as will be described below, there was a case where the metal to be added in very small amount was not detected in the analysis of the plated film in ICP.

When the content of the metal to be added in very small amount is lower than 20 ppm based on tin, significant improvement of solderability by the metal to be added in very small amount has not been observed. It has been confirmed that, although the solderability was improved along with an increase in the content, the metal to be added in very small amount was dissolved into a mimic corrosive solution from the plated film obtained from a bath to which a large amount of the metal has been added. Thereby, it has been confirmed that it is important to limit the content of the metal to be added in very small amount to 2,000 ppm or lower in consideration of influences on the environment.

In the present specification, the tin plating bath is defined as a plating bath in which the content of a metal other than tin and the above metal to be added in very small amount is lower than 0.1% based on tin, and the tin alloy plating bath is defined as a plating bath containing at least 0.1% of one or more metals selected from alloying elements as metal(s) other than the above metal to be added in very small amount.

The present invention is a plating bath of tin or an alloy of tin and one or more metals selected from the following group (I): copper, zinc, silver, indium, gold and bismuth, which bath comprise, as essential components, at least the following components (A) to (D):

(A) 5 to 200 g/L of divalent tin ions;

(B) one or more acids or complexing agents which form a water-soluble salt or complex with the divalent tin ions, the total amount of the acid(s) or complexing agent(s) being at least stoichiometrically equivalent to the divalent tin ions;

(C) one or more metals selected from elements of IB to VB Groups of the fourth to sixth periods of the periodic table of the elements excluding tin, mercury, thallium and elements included in the group (I), the total concentration of the metal(s) being 20 to 2,000 ppm based on tin; and

(D) one or more antioxidants.

The plating bath of the present invention contains divalent tin ions as a first essential component. The concentration of the divalent tin ions is suitably 5 to 200 g/L, more preferably 10 to 100 g/L. It is suitably used at a relatively low concentration for the barrel plating or the like, while it is suitably used at a relatively high concentration for the high-speed plating or the like.

The divalent tin ions can be added to the plating bath as a salt or complex formed from the reaction of the divalent tin ions and the acid or complexing agent as described later, which forms a water-soluble salt or complex with the divalent tin ions, or as an aqueous solution thereof.

The plating bath further contains, as a second essential component, one or more acids or complexing agents which form a water-soluble salt or complex with the divalent tin ions, in such a total amount which is at least stoichiometrically equivalent to the divalent tin ions.

A concentration of a free acid or complexing agent in the acid or complexing agent which forms a water-soluble salt or complex with the divalent tin ions is preferably 1 to 500 g/L, more preferably 1 to 300 g/L, most preferably not higher than 200 g/L. The free acid or complexing agent is an acid or complexing agent which is present without bonding to the divalent tin ions when the above acid or complexing agent is contained in such a total amount which is at least stoichiometrically equivalent to the divalent tin ions.

Referred acids or complexing agents which form a water-soluble salt or complex with the divalent tin ions, include:

one or more acids selected from sulfuric acid, hydrochloric acid, fluoroboric acid, hydrosilicofluoric acid, sulfamic acid, acetic acid, phosphoric acid and(or) condensed phosphoric acid;

aliphatic sulfonic acids represented by the following general formula (I):

(X₁)ₙ—R₁—SO₃H

wherein R₁ represents a C₁ to C₅ alkyl radical, X₁ represents hydrogen, a hydroxyl group, an alkyl radical, an aryl radical, an alkylaryl radical, a carboxyl group or a sulfonic acid group and may be at any position of the alkyl radical, and n is an integer of 0 to 3; and the following general formula (II):

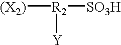

wherein R₂ represents a C₁ to C₅ alkyl radical or C₁ to C₃-alkylene radical, and hydroxyl group(s) may be present at any position of the alkylene radical; X₂ represents halogen atoms, i.e., chlorine and/or fluorine, the number of chlorine and/or fluorine which substituted hydrogen(s) on the alkyl or alkylene radical ranges from 1 to a value at which all the hydrogens bonded to the alkyl or alkylene radical were substituted, the species of the halogen are one or two, and the chlorine or fluorine substituent may be present at any position; and Y represents hydrogen or a sulfonic acid group, and the number of the sulfonic acid substituent represented by Y ranges from 0 to 2;

aromatic sulfonic acids represented by the following general formula (III):

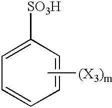

wherein X₃ represents a hydroxyl group, an alkyl radical, an aryl radical, an alkylaryl radical, an aldehyde group, a carboxyl group, a nitro group, a mercapto group, a sulfonic acid group or an amino group, and two X₃s can form a naphthalene ring in combination with the benzene ring; and m is an integer of 0 to 3; and

carboxylic acids or complexing agents selected from the following (a) to (h):

(a) an aliphatic dicarboxylic acid with an alkyl moiety having 0 to 3 carbon atoms (such as oxalic acid, malonic acid and succinic acid),

(b) an aliphatic hydroxymonocarboxylic acid with an alkyl moiety having 1 or 2 carbon atoms (such as glycolic acid and lactic acid),

(c) an aliphatic hydroxypolycarboxylic acid with an alkyl moiety having 1 to 3 carbon atoms (such as tartaric acid, citric acid, tartronic acid and malic acid),

(d) a polyhydroxycarboxylic acid obtained by partial oxidation of monosaccharides (such as ascorbic acid, glucoheptonic acid and gluconic acid),

(e) an aliphatic mono- or diamino mono- or dicarboxylic acid with an alkyl moiety having 1 to 4 carbon atoms (such as glycine, alanine, valine, leucine, isoleucine, lysine, serine, threonine, phenylalanine, aspartic acid, glutamic acid and methionine),

(f) an aliphatic monomercaptomonocarboxylic acid, aliphatic monomercaptodicarboxylic acid or aliphatic monomercaptomonoaminomonocarboxylic acid with an alkyl moiety having 2 or 3 carbon atoms (such as mercaptosuccinic acid and cystine),

(g) an aliphatic monosulfomonocarboxylic acid with an alkyl moiety having 2 or 3 carbon atoms (such as sulfosuccinic acid), and

(h) the following aminecarboxylic acids; ethylenediaminetetraacetic acid, iminodiacetic acid, nitrilotriacetic acid, diethylenetriaminepentaacetic acid, triethylenetetraminehexaacetic acid, ethylenedioxybis(ethylamine)-N,N,N′,N′-tetraacetic acid, glycol ethylenediaminetetraacetic acid and N-hydroxyethylethylenediaminetetraacetic acid,

are suitably used.

Of these, aliphatic or aromatic organic sulfonic acids such as methanesulfonic acid, 2-propanolsulfonic acid, trifluoromethanesulfonic acid and phenolsulfonic acid, or carboxylic acids or complexing agents such as tartaric acid, gluconic acid, citric acid and EDTA are more preferably used.

The plating bath further contains, as a third essential component, one or more metals to be added in very small amount, i.e., a metal selected from elements of Groups IB to VB of the fourth to sixth periods of the periodic table of the elements excluding tin, mercury, thallium and the aforementioned alloying metal, in a total amount of 20 to 2,000 ppm based on tin. More specifically, the plating bath contains one or more metals selected from antimony, arsenic, cadmium, germanium, gallium or lead. Addition of these metals within the above range significantly improves solderability.

The above metal to be added in very small amount is effective even if added alone or in combination of two or more and are suitably used. And, antimony, arsenic, cadmium, germanium or gallium is more preferably used and, of these, antimony and arsenic are most preferably used.

As will be described in Examples later, when the above metal is contained in a total amount of 20 ppm or more based on the tin ions, solderability and aging characteristics of the tin or tin alloy deposit are significantly improved as compared with a case where these metals are not contained. In developing a plating bath for use in the deposition of a lead-free soldering film, many attempts have been made by the prior developer to completely remove these harmful metals including; lead and these attempts to be made the development thereof more difficult. According to the present invention, by adding these metals to the plating bath in such a very small amount that does not exert a significantly great influence on the environment, a plated film having solderability of a practically usable level was obtained, and thus environmental problems caused by lead in soldering technique have been solved.

The metal to be added in very small amount can also be added to the plating bath as a salt or complex of the metal with an acid or complexing agent which form a water-soluble salt or complex with the above divalent tin ions, or as an aqueous solution thereof. Further, as will be described later, the metal to be added in very small amount can be dissolved in a tin salt solution and/or an acid or complexing agent solution and then fed to the plating solution.

Particularly suitable are metal salts of known acids such as sulfuric acid, hydrochloric acid, fluoroboric acid, hydrosilicofluoric acid, sulfamic acid and pyrophosphoric acid; metal salts of aliphatic or aromatic sulfonic acids such as methanesulfonic acid, 2-propanolsulfonic acid, trifluoromethanesulfonic acid and phenolsulfonic acid; and metal salts of various carboxylic acids such as tartaric acid, gluconic acid, citric acid and EDTA. These salts can also be added to the plating bath per se or in the form of an aqueous solution. For example, even a compound such as lead sulfate which is difficultly dissolved in an aqueous solution can be often dissolved easily in an acid or complexing agent such as an organic sulfonic acid or a fluoroboric acid within the concentration range according to the present invention.

As will be described later, it is preferred for the present plating bath to contain tetravalent tin ions or a tin compound is contained at a certain concentration. Meanwhile, since the tetravalent tin has an adverse effect if present beyond its limit, the tin or tin alloy plating bath of the present invention preferably contains, as a fourth essential component, one or more antioxidants in a total concentration of at least 1 mg/L to 10 g/L, more preferably 5 mg/L to 2 g/L, most preferably 10 mg/L to 1 g/L, so as to prevent the concentration of the tetravalent tin compound or ion from increasing beyond its limit. When the amount of the fourth essential component is larger than about 10 g/L, smoothness of the plated film may be impaired, contrarily.

As the antioxidants, (i) one or more benzene or naphthalene derivatives selected from compounds in which 1 to 6 hydrogen atoms on the benzene ring or naphthalene ring are substituted with a hydroxyl group and compounds obtained by further incorporating a carboxyl group or a sulfonic acid group into the substituted compounds, (ii) one or more aliphatic polyhydroxy compounds, or the like are suitably used.

Specific examples of more suitable ones among the above benzene or naphthalene derivatives (i) include catechol, resorcinol, hydroquinone, pyrogallol, hydroxyhydroquinone, phloroglucine, 3,4,5-trihydroxybenzoic acid, p-phenolsulfonic acid, cresolsulfonic acid, catecholsulfonic acid, hydroquinonesulfonic acid, gallic acid and β-naphthol, and specific examples of more suitable ones among the above aliphatic polyhydroxy compounds (ii) include L-sorbic acid, sorbitol, dextrose and isoascorbic acid. In addition, hypophosphates and hydrazine hydrate are also suitably used.

Further, the present plating bath further contains tetravalent tin ions or a tetravalent tin compound in an amount of 0.1 to 20 g/L, more preferably 0.1 to 10 g/L.

In the deposition of the tin or tin alloy from the divalent tin ions, the tetravalent tin ions should not be directly involved in the precipitation of tin. However, according to the studies made by us, the following has been found. That is, strictly speaking, the concentration of the tetravalent tin ions depends on the type of the baths and is not necessarily constant, and when the concentration exceeds 20 g/L, the tetravalent tin ions surely injures and adversely affects uniformity of the plated film; however, when the concentration is 0.1 to 20 g/L, the tetravalent tin ions provide a plated film having good solderability. It is frequently observed that a colloidal substance improves smoothness of the plated film, and there is a possibility that the presence of the tetravalent tin ions or tin compound has such an effect.

The tetravalent tin ions or compound can be present in the bath by oxidizing the divalent tin ions in the bath by means of a forcible method such as air agitation or preliminary electrolysis, or by adding a compound such as a stannate or tin tetrachloride.

The concentration of the tetravalent tin in the bath can be analyzed and controlled by measuring the concentration of all the tins present in the bath by means of ICP analysis or atomic absorption analysis and subtracting the analyzed value of the divalent tin obtained by means of redox titration from the measured concentration of all the of tins. When the concentration of all the tins cannot be analyzed by the use of instruments, it can be analyzed by means of redox titration after having dissolving metal aluminum under acid conditions so as to reduce tetravalent tin to divalent tin.

The plating bath used in the present invention can contain one or more aliphatic alcohols or ketones having 1 to 10 carbon atoms in a total amount of 0.1 to 200 g/L. The aliphatic alcohols or ketones more preferably have 1 to 6 carbon atoms. The alcohols or ketones have an effect of smoothing the plated film, and it is assumed that this, together with the inclusion of the aforementioned antimony, arsenic, cadmium, germanium, gallium or lead, improves solderability. Since the addition of the aliphatic alcohols or ketones in an excess amount impairs smoothness of the plated film, it is desirable to add then in an amount of not higher than 200 g/. Further, from the viewpoint of adverse effects exerted on the working environment by a smell of alcohols or ketones which can generate from the plating bath, the amount of the aliphatic alcohols or ketones must be limited to 200 g/L or lower.

More specifically, the preferred alcohols are one or more aliphatic alcohols having 1 to 10 carbon atoms selected from aliphatic branched or non-branched alcohols represented by the following general formulae (a) to (c):

Linear saturated aliphatic mono- or di-alcohols represented by the general formula (a):

CₙH₂ₙ₊₂₋ₘ(X)ₘ

wherein n is larger than m and is an integer of not larger than 10, and m represents an integer of 1 or 2; and Xs are hydrogen or a hydroxyl group and may be the same or different, at least one of the Xs is a hydroxyl group, the Xs can be bonded to any position of the carbon chain, and the carbon chain may be linear or branched;

cyclic saturated aliphatic mono- or di-alcohol represented by the general formula (b):

CₙH₂ₙ₋ₘ(X)ₘ

wherein n is larger than m and is an integer of not larger than 10, and m represents an integer of 1 or 2; and Xs are hydrogen or a hydroxyl group and may be the same or different, at least one of the Xs is a hydroxyl group, the Xs can be bonded to any position of the carbon chain, and the carbon chain may be branched; and

linear saturated aliphatic mono- or di-alcohols having an ether linkage and represented by the general formula (c):

CₙH₂ₙ₊₂₋ₘOₗ(X)ₘ

wherein n is larger than m and is an integer of not larger than 10, m represents an integer of 1 or 2, and l represents an integer of not larger than n−2; Xs are hydrogen or a hydroxyl group and may be the same or different, at least one of the Xs is a hydroxyl group, the Xs can be bonded to any position of the carbon chain, and the carbon chain may be branched; and O represents an ethereal oxygen which may be present between any two carbon atoms.

To be more specific, methanol, ethanol, (n- and iso-)propanols, ethylene glycol, propylene glycol, and linear and branched butanols, pentanols and hexanols are suitably used as the aliphatic linear alcohol; cyclohexanol is suitably used as the aliphatic cyclic alcohol; and ethylene glycol monomethyl ether and ethylene glycol monoethyl ether are suitably used as the alcohol having an ether linkage. More preferably, methanol, ethanol and (n- and iso-) propanols are used. Further, as the aliphatic ketones, acetone and methyl ethyl ketone are suitably used. Most preferably, (n- and iso-)propanols are used.

Further, the bath used in the present invention may also contain one or more components selected from a surfactant, a leveling agent, a semi-brightening agent, a brightening agent, a conductive salt, a pH regulator and a pH buffer.

To prepare, control and make up the above plating bath or to adjust a concentration of the plating bath, a tin salt solution having the essential components of the plating bath dissolved therein in advance is suitably used. The tin salt solution suitably used contains, as essential components, at least the following components (E) to (G):

(E) 50 to 500 g/L of divalent tin ions;

(F) one or more acids or complexing agents which form a water-soluble salt or complex with the divalent tin ions, the total amount of the acid(s) or complexing agent(s) being at least stoichiometrically equivalent to the divalent tin ions; and

(G) one or more metals selected from elements of Groups IB to VB of the fourth to sixth periods of the periodic table of the elements excluding tin, mercury, thallium and the elements included in the above group (I), the total concentration of the metal(s) being 20 to 2,000 ppm based on tin.

The divalent tin ions which are a first essential component of the tin salt solution are preferably used in a concentration of 50 to 500 g/L, more preferably 100 to 250 g/L.

The tin salt solution contains, as a second essential component, one or more acids or complexing agents which form a water-soluble salt or complex with the divalent tin ions in such a total amount which is at least stoichiometrically equivalent to the divalent tin ions.

Of the acid or complexing agent which form a water-soluble salt or complex with the divalent tin ions, a concentration of a free acid or complexing agent in the tin salt solution is preferably 10 to 500 g/L, more preferably 50 to 300 g/L.

As the acids or complexing agents which form a water-soluble salt or complex with the divalent tin ions, those which already set forth in the section of description of the plating bath are suitably used.

As in the case of the plating bath, the tin salt solution contains, as a third essential component, one or more metals selected from elements of Groups IB to VB of the fourth to sixth periods of the periodic table of the elements excluding tin, mercury, thallium and the above alloying elements in a total amount of 20 to 2,000 ppm based on tin.

Further, the tin salt solution preferably contains an antioxidant as well. As the antioxidants, those mentioned above as the antioxidants to be added to the plating bath are suitably used. As for the concentration of the antioxidants, although they are effective when the concentration is 0.001 g/L or higher, the concentration of 0.01 to 100 g/L is generally used, more preferably in a concentration of 0.05 to 50 g/L.

As antioxidants which are suitably used, one or more of the antioxidants mentioned above with respect to the plating bath are selected and used.

Since it is desirable to feed the tetravalent tin ions or compounds to the plating bath continuously, the tin salt solution is suitably used by containing tetravalent tin ions or compound as well. An appropriate concentration of the tetravalent tin ions or compound in the tin salt solution is determined in consideration of generation of precipitates and the like, and a concentration of 0.1 to 20 g/L is suitably used, as in the case of the plating bath.

Further, as in the case of the plating bath, the tin salt solution preferably contains one or more aliphatic alcohols or ketones having 1 to 10 carbon atoms. A preferred total concentration of the aliphatic alcohol or ketone in the tin salt solution is 0.1 to 200 g/L.

As the alcohols which are suitably used, one or more of those mentioned above with respect to the plating bath are selected and used.

In addition, the tin salt solution may also contain other components to be contained in the plating bath, i.e., one or more components selected from a surfactant, a leveling agent, a semi-brightening agent, a brightening agent, a conductive salt, a pH regulator and a pH buffer.

The solution of the acid or complexing agent which forms a water-soluble salt or complex with divalent tin ions, i.e., the solution used for preparing, controlling and making up the tin plating bath or the tin alloy plating bath, or for adjusting a concentration of the bath, may also contain a component to be contained in the plating bath, i.e., one or more components selected from an antioxidant, an aliphatic alcohol or ketone having 1 to 10 carbon atoms, a surfactant, a leveling agent, a semi-brightening agent, a brightening agent, a conductive salt, a pH regulator and a pH buffer.

Electrical and electric components plated with tin or a tin alloy by the use of the aforementioned tin plating bath or tin alloy plating bath, such as a semiconductor device, a printed circuit board, a flexible printed circuit board, a film carrier, a connector, a switch, a resistor, a variable resistor, a condenser, a filter, an inductor, a thermistor, a quartz oscillator, a lead wire and an electrode for a battery, are suitably used as electrical and electric components having good solderability.

### EXAMPLES

Hereinafter, the present invention will be described in detail with reference to Examples. However, the present invention shall not be limited to these Examples.

By the following Examples and Comparative Examples, effects of the addition of the metal to be added in very small amount and effects of the antioxidants were checked. Tin salt solutions were prepared by dissolving a commercially available 4N metal tin in an acid solution through electrolysis. Values of contents of impurities in the metal tin are as shown in Table 1.

TABLE 1

| Sb | As | Cd | Pb | Cu | Ag | Bi | Fe | Ni | Ge | Ga |
|---|---|---|---|---|---|---|---|---|---|---|
| 8 | 1 | <1 | 9 | 4 | <1 | 1 | 1 | <1 | <1 | <1 |

unit: ppm

After depositing 10-μm plated films on copper plate samples having a size of 5 mm×30 mm by the use of plating baths shown in the Examples, the samples were heat-treated at about 150° C. for 5 hours, and then zero cross times were measured through the use of a Meniscograph so as to evaluate whether solderability was good or not. Regardless of the types of the plated films, in order to measure all the samples under the same conditions, the measurements by the Meniscograph were carried out at 240° C. by the use of a silver-tin solder and a rosin flux. The results of evaluations of the solderability are shown in Table 2.

In preparing plating baths containing a metal to be added in very small amount, tin salt solutions in which the metal to be added in very small amount has been dissolved were prepared in advance, and then plating baths were prepared by the use of the tin salt solutions. In a case where a metal to be added in very small amount was not added, plating baths were prepared by the use of tin salt solutions which do not contain the metal.

Further, in a case where an antioxidant is added, acid solutions containing the antioxidant was prepared in advance and then used to prepare plating baths. To prepare plating baths containing no antioxidant, acid solutions containing no antioxidant was used.

### Example 1

A sample of a plated film was prepared by the use of the following plating bath and plating conditions (1-A).

Plating Bath and Plating Conditions (1-A)

| | |
|---|---|
| Tin methanesulfonate (as tin) | 100 g/L |
| Methanesulfonic acid | 150 g/L |
| Arsenious acid (as arsenic) | 25 mg/L |
| Antimony trichloride (as antimony) | 70 mg/L |
| Catechol | 3 mg/L |
| Cetyl dimethylbenzyl ammonium hydroxide | 5 g/L |
| N-(3-Hydroxybutylidene)-p-sulfanilic acid | 2 g/L |
| Isopropanol | 5 g/L |
| Bath temperature | 35° C. |
| Cathode current density | 10 A/dm² |

### Comparative Example 1

A sample of a plated film was prepared under the same conditions as in (1-A) above except that arsenic and antimony were not added (1-B).

### Example 2

A sample of a plated film was prepared by the use of the following plating bath and plating conditions (2-A).

Plating Bath and Plating Conditions (2-A)

| | |
|---|---|
| Tin methanesulfonate (as tin) | 100 g/L |
| Methanesulfonic acid | 150 g/L |
| Cadmium sulfate (as cadmium) | 65 mg/L |
| Gallium chloride (as gallium) | 25 mg/L |
| Catechol | 3 mg/L |
| Cetyl dimethylbenzyl ammonium hydroxide | 5 g/L |
| N-(3-Hydroxybutylidene)-p-sulfanilic acid | 2 g/L |
| Methanol | 10 g/L |
| Bath temperature | 35° C. |
| Cathode current density | 10 A/dm² |

### Comparative Example 2

A sample of a plated film was prepared under the same conditions as in (2-A) above except that cadmium and gallium were not added (2-B).

### Example 3

A sample of a plated film was prepared by the use of the following plating bath and plating conditions (3-A).

Plating Bath and Plating Conditions (3-A)

| | |
|---|---|
| Stannous sulfate (as tin) | 39 g/L |
| Sulfuric acid | 50 g/L |
| Cresolsulfonic acid | 60 g/L |
| Antimony trichloride (as antimony) | 30 mg/L |
| Catecholsulfonic acid | 30 mg/L |
| Formalin | 8 ml/L |
| No-1 (Ishihara Yakuhin K.K.) | 15 g/L |
| No-2 (Ishihara Yakuhin K.K.) | 20 ml/L |
| Isopropanol | 50 g/L |
| Bath temperature | 20° C. |
| Cathode current density | 2 A/dm² |

### Comparative Example 3

A sample of a plated film was prepared under the same conditions as in (3-A) above except that antimony was not added (3-B).

### Example 4

A sample of a plated film was prepared by the use of the following plating bath and plating conditions (4-A).

Plating Bath and Plating Conditions (4-A)

| | |
|---|---|
| Tin 2-hydroxypropanesulfonate (as tin) | 20 g/L |
| 2-Hydroxypropanesulfonic acid | 100 g/L |
| Lead sulfate (as lead) | 35 mg/L |
| Resorcinol | 100 mg/L |
| Dimethylbenzyllauryl ammonium chloride | 3 g/L |
| N-(3-Hydroxybutylidene)-p-sulfanilic acid | 1 g/L |
| Ethanol | 100 g/L |
| Bath temperature | 25° C. |
| Cathode current density | 5 A/dm² |

### Comparative Example 4

A sample of a plated film was prepared under the same conditions as in (4-A) above except that lead was not added (4-B).

### Example 5

A sample of a plated film was prepared by the use of the following plating bath and plating conditions (5-A).

Plating Bath and Plating Conditions (5-A)

| | |
|---|---|
| Tin fluoroborate (as tin) | 122 g/L |
| Fluoroboric acid | 200 g/L |
| Boric acid | 25 g/L |
| Germanium chloride (as germanium) | 2 mg/L |
| Lead fluoroborate (as lead) | 2 mg/L |
| Hydroquinone | 2,000 mg/L |
| β-Naphthol | 1,000 mg/L |
| Peptone | 5 g/L |
| Bath temperature | 20° C. |
| Cathode current density | 5 A/dm² |

### Comparative Example 5

A sample of a plated film was prepared under the same conditions as in (5-A) above except that lead was not added (5-B).

### Example 6

The above plating bath (5-A) was air-bubbled so as to produce tetravalent tin ions in the bath. As a result of analysis, 7.6 g/L of tetravalent tin ions were contained. The reduced portion of the divalent tin ions was replenished with new divalent tin ions so as to prepare a plating bath having the same conditions as in (5-A) above except for the concentration of the tetravalent tin ions, and a sample of a plated film was prepared. The conditions will be referred to as (6-A).

### Comparative Example 6

A sample of a plated film was prepared under the same conditions as in (6-A) above except that lead was not added (6-B).

### Example 7

A sample of a plated film was prepared by the use of the following plating bath and plating conditions (7-A).

Plating Bath and Plating Conditions (7-A)

| | |
|---|---|
| Tin fluoroborate (as tin) | 122 g/L |
| Fluoroboric acid | 200 g/L |
| Boric acid | 25 g/L |
| Antimony trichloride (as antimony) | 3 mg/L |
| Hydroquinone | 1,000 mg/L |
| β-Naphthol | 1,000 mg/L |
| Peptone | 5 g/L |
| Bath temperature | 20° C. |
| Cathode current density | 5 A/dm² |

### Comparative Example 7

A sample of a plated film was prepared under the same conditions as in (7-A) above except that lead was not added (7-B).

### Example 8

A sample of a plated film was prepared by the use of the following plating bath and plating conditions (8-A).

Plating Bath and Plating Conditions (8-A)

| | |
|---|---|
| Tin methanesulfonate (as tin) | 24 g/L |
| Silver methanesulfonate (as silver) | 0.54 g/L |
| Methanesulfonic acid | 72 g/L |
| Tris(3-hydroxypropyl) phosphine | 83 g/L |
| Antimony trichloride (as antimony) | 10 mg/L |
| Lead methanesulfonate (as lead) | 5 mg/L |
| Arsenious acid (as arsenic) | 2 mg/L |
| Germanium chloride (as germanium) | 3 mg/L |
| Gallium chloride (as gallium) | 5 mg/L |
| Cadmium sulfate (as cadmium) | 6 mg/L |
| Hydroquinone | 500 mg/L |
| NOIGEN EN | 1 g/L |
| TEXNOL R5 | 1 g/L |
| NOXELAR M60 | 0.1 g/L |
| Isopropanol | 40 g/L |
| Bath temperature | 30° C. |
| Cathode current density | 5 A/dm² |

### Comparative Example 8

A sample of a plated film was prepared under the same conditions as in (8-A) above except that various elements to be added in very small amount were not added (8-B).

### Example 9

A sample of a plated film was prepared by the use of the following plating bath and plating conditions (9-A).

Plating Bath and Plating Conditions (9-A)

| | |
|---|---|
| Tin sulfate (as tin) | 12 g/L |
| Bismuth sulfate (as bismuth) | 1 g/L |
| Sodium gluconate | 131 g/L |
| EDTA-4Na dihydrate | 4.5 g/L |
| Antimony trichloride (as antimony) | 4 mg/L |
| 3,4,5-Trihydroxybenzoic acid | 600 mg/L |
| PEG#6000 | 1 g/L |
| TRITON X | 1 g/L |
| Formalin (37%) | 1 ml/L |
| Ethylene glycol | 50 g/L |
| pH | 4.3 |
| Bath temperature | 25° C. |
| Cathode current density | 0.5 A/dm² |

### Comparative Example 9

A sample of a plated film was prepared under the same conditions as in (9-A) above except that antimony was not added (9-B).

### Example 10

A sample of a plated film was prepared by the use of the following plating bath and plating conditions (10-A).

Plating Bath and Plating Conditions (10-A)

| | |
|---|---|
| Tin sulfamate (as tin) | 12 g/L |
| Indium sulfamate (as indium) | 11 g/L |
| Sulfosuccinic acid | 212 g/L |
| 2,2′-Dithiodianiline | 0.75 g/L |
| Antimony trichloride (as antimony) | 2 mg/L |
| Lead sulfate (as lead) | 2 mg/L |
| Pyrogallol | 5,000 mg/L |
| Polyoxyethylene-α-naphthol (number of moles of the | 3 g/L |
| added EO = 10) | |
| Polyethylene glycol #1000 | 2 g/L |
| t-Butyl alcohol | 10 g/L |
| pH | 2.3 |
| Bath temperature | 25° C. |
| Cathode current density | 1.5 A/dm² |

### Comparative Example 10

A sample of a plated film was prepared under the same conditions as in (10-A) above except that antimony and lead were not added (10-B).

### Example 11

A sample of a plated film was prepared by the use of the following plating bath and plating conditions (11-A).

Plating Bath and Plating Conditions (11-A)

| | |
|---|---|
| Tin phenolsulfonate (as tin) | 23 g/L |
| Indium sulfamate (as indium) | 11 g/L |
| Copper sulfate (as copper) | 0.165 g/L |
| Silver methanesulfonate (as silver) | 0.07 g/L |
| Methanesulfonic acid | 192 g/L |
| Tris(3-hydroxypropyl) phosphine | 1.9 g/L |
| 2,2′-Dithiodianiline | 3.8 g/L |
| Lead phenolsulfonate (as lead) | 10 mg/L |
| Germanium chloride (as germanium) | 10 mg/L |
| Resorcinol | 25 mg/L |
| Isopropanol | 20 g/L |
| Bath temperature | 20° C. |
| Cathode current density | 3 A/dm² |

### Comparative Example 11

A sample of a plated film was prepared under the same conditions as in (11-A) above except that lead and germanium were not added (11-B).

### Example 12

A sample of a plated film was prepared by the use of the following plating bath and plating conditions (12-A).

Plating Bath and Plating Conditions (12-A)

| | |
|---|---|
| Tin sulfamate (as tin) | 23 g/L |
| Zinc sulfate (as zinc) | 0.46 g/L |
| Sulfosuccinic acid | 212 g/L |
| Tris(3-hydroxypropyl) phosphine | 1.9 g/L |
| 2,2′-Dithiodianiline | 3.8 g/L |
| Cadmium sulfate (as cadmium) | 20 mg/L |
| Gallium chloride (as gallium) | 20 mg/L |
| Gallic acid | 15 mg/L |
| Isopropanol | 150 g/L |
| Bath temperature | 25° C. |
| Cathode current density | 1 A/dm² |

### Comparative Example 12

A sample of a plated film was prepared under the same conditions as in (12-A) above except that cadmium and gallium were not added (12-B).

### Example 13

A sample of a plated film was prepared by the use of the following plating bath and plating conditions (13-A).

Plating Bath and Plating Conditions (13-A)

| | |
|---|---|
| Tin 2-hydroxypropanesulfonate (as tin) | 15 g/L |
| 2-Hydroxypropanesulfonic acid | 40 g/L |
| Lead sulfate (as lead) | 30 mg/L |
| Sodium gluconate | 190 g/L |
| Oxalic acid | 10 g/L |
| Polyoxyethylene-α-naphthol (number of moles of the | 2 g/L |
| added EO = 13) | |
| Catechol | 100 mg/L |
| Isopropanol | 60 g/L |
| Adjusted to a pH of 4.0 with sodium hydroxide | |
| Bath temperature | 25° C. |
| Cathode current density | 1.0 A/dm² |

### Comparative Example 13

A sample of a plated film was prepared under the same conditions as in (13-A) above except that lead was not added (13-B).

### Example 14

A sample of a plated film was prepared by the use of the following plating bath and plating conditions (14-A).

Plating Bath and Plating Conditions (14-A)

| | |
|---|---|
| Tin isethionate (as tin) | 25 g/L |
| Isethionic acid | 70 g/L |
| Antimony trichloride (as antimony) | 30 mg/L |
| Potassium gluconate | 190 g/L |
| Potassium acetate | 10 g/L |
| Polyoxyethylene lauryl ether (number of moles of the added | 2 g/L |
| EO = 12) | |
| Hydroquinone | 80 mg/L |
| t-Butanol | 1 g/L |
| Adjusted to a pH of 5.5 with ammonia | |
| Bath temperature | 25° C. |
| Cathode current density | 1.0 A/dm² |

### Comparative Example 14

A sample of a plated film was prepared under the same conditions as in (14-A) above except that antimony was not added (14-B).

### Example 15

A sample of a plated film was prepared by the use of the following plating bath and plating conditions (15-A).

Plating Bath and Plating Conditions (15-A)

| | |
|---|---|
| Tin sulfate (as tin) | 20 g/L |
| Copper sulfate (as copper) | 1 g/L |
| Sulfuric acid | 200 g/L |
| Cadmium sulfate (as cadmium) | 20 mg/L |
| Arsenious acid (as arsenic) | 15 mg/L |
| Catecholsulfonic acid | 50 mg/L |
| Polyoxyethylene lauryl ether (number of moles of the added | 2 g/L |
| EO = 6) | |
| Cyclohexanol | 0.5 g/L |
| pH | 4.3 |
| Bath temperature | 20° C. |
| Cathode current density | 2 A/dm² |

### Comparative Example 15

A sample of a plated film was prepared under the same conditions as in (15-A) above except that catecholsulfonic acid was not added (15-B).

From the bath (15-A) a good plated film could still be obtained even after one week, but the bath (15-B) started to fail to produce a good plated film after two days.

### Comparative Example 16

A sample of a plated film was prepared under the same conditions as in (4-A) above except that lead was added in an amount of 45 mg/L (4-c).

The sample prepared under the conditions (4-A) and the sample prepared under the conditions (4-C) were immersed in mimic corrosive solutions (aqueous solutions each comprising 100 ppm of Cl⁻, 100 ppm of HCO₃⁻ and 100 ppm of SO₄²⁻) for 30 days so as to analyze lead in the solutions by atomic absorption analysis. The content of lead in the solution in which the sample prepared under the conditions (4-A) has been immersed did not exceed a detection limit, but 0.2 ppm of lead was detected from the solution in which the sample prepared under the conditions (4-C) has been immersed.

### Comparative Example 17

A sample of a plated film was prepared under the same conditions as in (8-A) above in Example 8 except that isopropanol was not added (8-C). Zero cross time was decreased due to addition of alcohols.

Zero cross times indicating solderability of the samples prepared under the conditions of the above Examples and Comparative Examples are shown in Table 2.

TABLE 2

| | Solderability |
|---|---|
| | (Zero Cross Time) (seconds) |
| Example 1 | 3.1 |
| Comp. Example 1 | 7.5 |
| Example 2 | 3.9 |
| Comp. Example 2 | 7.4 |
| Example 3 | 2.8 |
| Comp. Example 3 | 5.9 |
| Example 4 | 3.0 |
| Comp. Example 4 | 6.9 |
| Example 5 | 4.3 |
| Comp. Example 5 | 7.1 |
| Example 6 | 4.8 |
| Comp. Example 6 | 7.6 |
| Example 7 | 5.5 |
| Comp. Example 7 | 7.4 |
| Example 8 | 2.9 |
| Comp. Example 8 | 6.0 |
| Example 9 | 2.3 |
| Comp. Example 9 | 5.7 |
| Example 10 | 1.9 |
| Comp. Example 10 | 4.3 |
| Example 11 | 2.5 |
| Comp. Example 11 | 6.1 |
| Example 12 | 3.7 |
| Comp. Example 12 | 6.9 |
| Example 13 | 3.1 |
| Comp. Example 13 | 6.8 |
| Example 14 | 3.9 |
| Comp. Example 14 | 7.2 |
| Example 15 | 3.1 |
| Comp. Example 15 | 6.5 |
| Comp. Example 16 | 2.7 |
| Comp. Example 17 | 3.3 |

It is understood from comparisons between Examples 1 to 14 and Comparative Examples 1 to 14 that solderability after a passage of time was significantly improved by the additions of the metals to be added in very small amount.

It is understood from comparisons between Examples 5 and 6 and Comparative Examples 5 and 6 that, although the tetravalent tin in the baths is not an essential component, it, together with the additions of the metal to be added in very small amount, shows a synergistic effect on solderability. Further, effects caused by the addition of alcohols can be confirmed from comparison of Example 17 with Comparative Example 17.

By adding to tin and tin alloy plating baths a very small amount of lead for which researchers and developers of lead-free solderable films have heretofore attempted to remove it completely therefrom, the solderability of the tin and tin alloy plated films could be significantly improved. In addition, the solderability could be significantly improved by adding metals other than lead whose addition to the lead-free plating baths in a very small amount has heretofore not been considered due to the toxicity and costs, i.e., low-melting metals which can be found in the vicinity of lead in the periodic table of the elements and are not a component of the tin alloy plating baths, more specifically, metals such as arsenic, cadmium, antimony, gallium and germanium, to the tin or tin alloy plating baths in a minimum required concentration in consideration of the environment.

What is claimed is:

1. A plating bath of tin or an alloy of tin and one or more metals selected from the following group (I): copper, zinc, silver, indium, gold and bismuth, which bath comprises, as essential components, at least the following components (A) to (D):
(A) 5 to 200 g/L of divalent tin ions,
(B) one or more acids or complexing agents which form a water-soluble salt or complex with the divalent tin ions, the total amount of the acid(s) or complexing agent(s) being at least stoichiometrically equivalent to the divalent tin ion;
(C) one or more metals selected from elements of Groups IB to VB groups of the fourth to sixth periods of the periodic table of the elements excluding tin, mercury, thallium and elements included in the group (I), the total concentration of the metal(s) being 20 to 2,000 ppm based on tin; and
(D) one or more antioxidants.

2. The bath of claim 1, wherein a total concentration of free acid(s) or complexing agent(s) in the acid(s) or complexing agent(s) (B) is 1 to 500 g/L.

3. The bath of claim 1 or 2, which further contains 0.1 to 20 g/L of tetravalent tin ions or a tetravalent tin compound.

4. The bath of any one of claims 1 to 3, which further contains one or more aliphatic alcohols or aliphatic ketones having 1 to 10 carbon atoms in a total amount of 0.1 to 200 g/L.

5. The bath of any one of claims 1 to 4, which further contains one or more components selected from a surfactant, a leveling agent, a semi-brightening agent, a brightening agent, a conductive salt, a pH regulator and a pH buffer.

6. A tin salt solution used for preparing, controlling or making up the bath of any one of claims 1 to 5 or for adjusting the concentration of the bath, which solution comprises, as essential components, at least the following components (E) to (G):
(E) 50 to 500 g/L of divalent tin ions;
(F) one or more acids or complexing agents which form a water-soluble salt or complex with the divalent tin ions, the total concentration of the acid(s) or complexing agent(s) being at least stoichiometrically equivalent to the divalent tin ions; and
(G) one or more metals selected from elements of Groups IB to VB Groups of the fourth to sixth periods of the periodic table of the elements excluding tin, mercury, thallium and elements included in the group (I), the total concentration of the metal(s) being 20 to 2,000 ppm based on tin.

7. The solution of claim 6, wherein a total concentration of free acid(s) or complexing agent(s) in the acid(s) or complexing agent(s) (F) is 10 to 500 g/L.

8. The solution of claim 6 or 7, which further contains one or more surfactants.

9. The solution of any one of claims 6 to 8, which further contains 0.1 to 20 g/L of tetravalent tin ions or a tetravalent tin compound.

10. The solution of any one of claims 6 to 9, which further contains one or more aliphatic alcohols or aliphatic ketones having 1 to 10 carbon atoms in a total amount of 0.1 to 200 g/L.

11. The solution of any one of claims 6 to 10, which further contains one or more components selected from a surfactant, a leveling agent, a semi-brightening agent, a brightening agent, a conductive salt, a pH regulator and a pH buffer.

12. A solution of one or more acids or complexing agents which form a water-soluble salt or complex with divalent tin ions and is used for preparing, controlling or making up the bath of any one of claims 1 to 5 or for adjusting a concentration of the bath, which solution comprises one or more components selected from an antioxidant, an aliphatic alcohol or ketone having 1 to 10 carbon atoms, a surfactant, a leveling agent, a semi-brightening agent, a brightening agent, a conductive salt, a pH regulator and a pH buffer.

13. The bath of any one of claims 1 to 5, the solution of any one of claims 6 to 11 or the solution of claim 12, wherein the acid or complexing agent is one or more acids selected from sulfuric acid, hydrochloric acid, fluoroboric acid, hydrosilicofluoric acid, sulfamic acid, acetic acid, phosphoric acid and(or) condensed phosphoric acid.

14. The bath of any one of claims 1 to 5, the solution of any one of claims 6 to 11 or the solution of claim 12, wherein the acid or complexing agent is one or more sulfonic acids selected from
aliphatic sulfonic acids represented by the following general formula (I):
(X₁)ₙ—R₁—SO₃H
wherein R₁ represents a C₁ to C₅ alkyl radical, X₁ represents hydrogen, a hydroxyl group, an alkyl radical, an aryl radical, an alkylaryl radical, a carboxyl group or a sulfonic acid group and may be at any position of the alkyl radical, and n is an integer of 0 to 3;
and the following general formula (II): 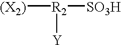
wherein R₂ represents a C₁ to C₅ alkyl radical or C₁ to C₃ alkylene radical, and hydroxyl group(s) may be present at any position of the alkylene radical; X₂ represents halogen atoms, i.e., chlorine and/or fluorine, the number of chlorine and/or fluorine which substituted hydrogen or the alkyl or alkylene radical ranges from 1 to a value at which all the hydrogens bonded to the alkyl or alkylene radical were substituted, the species of the halogen are one or two, and the chlorine or fluorine substituent may be present at any position; and Y represents hydrogen or a sulfonic acid group, and the number of the sulfonic acid substituent represented by Y ranges from 0 to 2; and
aromatic sulfonic acids represented by the following general formula (III): 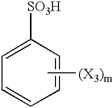
wherein X₃ represents a hydroxyl group, an alkyl radical, an aryl radical, an alkylaryl radical, an aldehyde group, a carboxyl group, a nitro group, a mercapto group, a sulfonic acid group or an amino group, and two X₃s can form a naphthalene ring in combination with the benzene ring; and m is an integer of 0 to 3.

15. The bath of any one of claims 1 to 5, the solution of any one of claims 6 to 11 or the solution of claim 12 or 14, wherein the aliphatic or aromatic sulfonic acid is one or more acids selected from methanesulfonic acid, ethanesulfonic acid, isethionic acid, 2-propanolsulfonic acid, phenolsulfonic acid, trifluoromethanesulfonic acid and cresolsulfonic acid.

16. The bath of any one of claims 1 to 5, the solution of any one of claims 6 to 11 or the solution of claim 12, wherein the acid or complexing agent comprises one or more ions of carboxylic acids selected from the following (a) to (h):
(a) an aliphatic dicarboxylic acid with an alkyl moiety having 0 to 3 carbon atoms,
(b) an aliphatic hydroxymonocarboxylic acid with an alkyl moiety having 1 or 2 carbon atoms,
(c) an aliphatic hydroxypolycarboxylic acid with an alkyl moiety having 1 to 3 carbon atoms,
(d) a polyhydroxycarboxylic acid obtained by partical oxidation of monosaccharides,
(e) an aliphatic mono- or diamino mono- or dicarboxylic acid with an alkyl moiety having 1 to 4 carbon atoms,
(f) an aliphatic monomercaptomonocarboxylic acid, aliphatic monomercaptodicarboxylic acid or aliphatic monomercaptomonoaminomonocarboxylic acid with an alkyl moiety having 2 or 3 carbon atoms,
(g) an aliphatic monosulfomonocarboxylic acid with an alkyl moiety having 2 or 3 carbon atoms, and
(h) the following aminecarboxylic acids: ethylenediaminetetraacetic acid, iminodiacetic acid, nitrilotriacetic acid, diethylenetriaminepentaacetic acid, triethylenetetraminehexaacetic acid, ethylenedioxybis(ethylamine)-N,N,N′,N′-tetraacetic acid, glycol ethylenediaminetetraacetic acid and N-hydroxyethylethylenediaminetetraacetic acid.

17. The bath of any one of claims 1 to 5, the solution of any one of claims 6 to 11 or the solution of any one of claims 12 to 16, wherein the antioxidant is one or more compounds selected from the following (i) and/or (ii):
(i) one or more benzene or naphthalene derivatives selected from compounds obtained by substituting 1 to 6 hydrogen atoms in the benzene or naphthalene ring with hydroxyl groups and compounds obtained by further incorporating a carboxyl group or a sulfonic acid group into the substituted compounds, and
(ii) aliphatic polyhydroxy compounds.

18. The bath of any one of claims 1 to 5, the solution of any one of claims 6 to 16 or the solution of claim 12, wherein the aliphatic alcohol having 1 to 10 carbon atoms is one or more aliphatic alcohols selected from aliphatic branched or non-branched alcohols represented by the following general formulae (a) to (c):
linear saturated aliphatic mono- or di-alcohols represented by the general formula (a):
CₙH₂ₙ₊₂₋ₘ(X)ₘ
wherein n is larger than m and is an integer of not larger than 10, and m represents an integer of 1 or 2; and Xs are hydrogen or a hydroxyl group and may be the same or different, at least one of the Xs is a hydroxyl group, the Xs can be bonded to any position of the carbon chain, and the carbon chain may be linear or branched;
cyclic saturated aliphatic mono- or di-alcohols represented by the general formula (b):
CₙH₂ₙ₋ₘ(X)ₘ
wherein n is larger than m and is an integer of not larger than 10, and m represents an integer of 1 or 2; and Xs are hydrogen or a hydroxyl group and may be the same or different, at least one of the Xs is a hydroxyl group, the Xs can be bonded to any position of the carbon chain, and the carbon chain may be branched; and
linear saturated aliphatic mono- or di-alcohols having an ether linkage and represented by the general formula (c):
CₙH₂ₙ₊₂₋ₘOₗ(X)ₘ
wherein n is larger than m and is an integer of not larger than 10, m represents an integer of 1 or 2, and l represents an integer of not larger than n−2; Xs are hydrogen or a hydroxyl group and may be the same or different, at least one of the Xs is a hydroxyl group, the Xs can be bonded to any position of the carbon chain, and the carbon chain may be branched; and O represents an ethereal oxygen which may be present between any two carbon atoms.

19. The bath of any one of claims 1 to 5, the solution of any one of claims 6 to 16 or the solution of claim 12, wherein the aliphatic ketone is one or more compounds selected from acetone or methyl ethyl ketone.

20. Electrical and electric components on which a tin or tin alloy deposit was plated by the use of the bath of any one of claims 1 to 5, such as a semiconductor device, a printed board, a flexible printed board, a film carrier, a connector, a switch, a resistor, a variable resistor, a condenser, a filter, an inductor, a thermistor, a quartz oscillator, a lead, and an electrode for a battery.
